(19) United States
(12) Patent Application Publication
(10) Pub. No.: US 2021/0304193 A1
(43) Pub. Date: Sep. 30, 2021

(54) METHODS AND SYSTEMS FOR PROVIDING A DIGITAL CURRENCY PAYMENT AND WALLET SOLUTION WITH HYBRID BLOCKCHAIN DESIGN

(71) Applicant: Carmelle Perpetuelle Maritza Racine Cadet, New York, NY (US)

(72) Inventor: Carmelle Perpetuelle Maritza Racine Cadet, New York, NY (US)

(21) Appl. No.: 17/212,382

(22) Filed: Mar. 25, 2021

Related U.S. Application Data
(60) Provisional application No. 63/000,910, filed on Mar. 27, 2020.
(60) Provisional application No. 63/037,989, filed on Jun. 11, 2020.

(51) Int. Cl. G06Q 20/36; G06Q 20/06

(52) U.S. Cl. CPC G06Q 20/3674; G06Q 20/3678; G06Q 20/065

(57) ABSTRACT

A method for implementing, within a blockchain platform having at least one anti-money laundering rule, pseudo-anonymous and confidential transaction processing for digital currency issued by a central bank includes receiving, by a digital wallet application executing on a computing device of a first user, from a server maintained by a central bank and maintaining a private blockchain network with at least one AML rule, an identification of a digital wallet provisioned for the first user. The method includes executing, by the digital wallet application, at least one transaction involving digital currency of the first user. The method includes retrieving, by the server, an enumeration of flagged transactions executed by the digital wallet application in association with the digital wallet and recorded in the private blockchain network, the enumeration of flagged transactions identifying transactions that violate the at least one AML rule and excluding the encrypted data.

### CROSS-REFERENCE TO RELATED APPLICATIONS

This application claims priority from U.S. Provisional Patent Application No. 63/000,910, filed on Mar. 27, 2020, entitled “Methods and Systems for Providing a Digital Currency Payment and Wallet Solution with Hybrid Blockchain Design,” and from U.S. Provisional Patent Application No. 63/037,989, filed on Jun. 11, 2020, entitled “Methods and Systems for Providing a Digital Currency Payment and Wallet Solution with Hybrid Blockchain Design,” each of which is hereby incorporated by reference.

### BACKGROUND

This disclosure relates to digital currency. More particularly, the methods and systems described herein relate to functionality for providing a digital currency payment and wallet solution with a hybrid blockchain design.

Physical cash has 100% availability and reliability; it is anonymous; it is an immediate direct medium of settlement. Physical cash allows the unbanked and under-banked to participate in the economy. Digital cash has the potential to supplement or replace physical cash, while reducing the fixed total cost for physical cash in circulation but must have these same characteristics. Given a highly concentrated paper model, introducing cash in digital form helps diversify the methods through which people—whether banked, unbanked, or underbanked—can get and use cash. Further, the use of digital cash, given the right design, should have little impact on the traditional banking sector, while contributing to market stability, economic growth and inclusion. However, should a central bank attempt to provide digital cash, many people will be leery of the government deploying digital cash into the economy. Therefore, there is a need for a technical platform that allows a central bank to issue legal tender in digital form, representing cash and allowing for availability, reliability, and a level of anonymity, while allowing for security and compliance with jurisdictional laws regarding the disclosure of information about specific transactions (e.g., anti-money laundering rules).

### BRIEF DESCRIPTION

In one aspect, a method for implementing, within a blockchain platform having at least one anti-money laundering (AML) rule, pseudo-anonymous and confidential transaction processing for digital currency issued by a central bank includes receiving, by a digital wallet application executing on a computing device of a first user, from a server maintained by a central bank and maintaining a private blockchain network with at least one AML rule, an identification of a digital wallet provisioned for the first user. The method includes executing, by the digital wallet application, at least one transaction involving digital currency of the first user. Executing the instruction includes executing, by the digital wallet application, in accordance with at least one smart contract in the private blockchain network, to record data associated with the execution of the transfer and to encrypt a subset of the recorded data in accordance with a privacy rule of the private blockchain network. The method includes retrieving, by the server from the private blockchain network, an enumeration of flagged transactions executed by the digital wallet application in association with the digital wallet and recorded in the private blockchain network, the enumeration of flagged transactions identifying transactions that violate the at least one AML rule and excluding the encrypted subset of the recorded data.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1 is a flow diagram depicting an embodiment of a method for implementing, within a blockchain platform having at least one anti-money laundering (AML) rule, pseudo-anonymous and confidential transaction processing for digital currency issued by a central bank;

FIG. 2A is a block diagram depicting an embodiment of a system for implementing, within a blockchain platform having at least one anti-money laundering (AML) rule, pseudo-anonymous and confidential transaction processing for digital currency issued by a central bank;

FIG. 2B is a block diagram depicting an embodiment of a system for implementing, within a blockchain platform having at least one anti-money laundering (AML) rule, pseudo-anonymous and confidential transaction processing for digital currency issued by a central bank; and

FIGS. 3A-3C are block diagrams depicting embodiments of computers useful in connection with the methods and systems described herein.

### DETAILED DESCRIPTION

Methods and systems for providing a digital currency payment and wallet solution, with hybrid blockchain design, allows legal tender to be issued in digital form while representing “cash” and uses tokenization features and blockchain technology to provide a trusted and secure payment platform. The system may include an application that is downloadable by an end user to receive and store digital legal tender in a digital wallet. Users may also transfer the digital legal tender to other wallets or accounts owned by themselves or by other parties.

The methods and systems described herein may provide a Sovereign Digital Cash Wallet application to anyone who does not have or use a bank account, or to those who do have bank accounts but who wish to perform banking transactions outside of conventional banking systems. The methods and systems described herein provide functionality that allow users to receive, send and pay with Central Bank Digital Currency in a “cash-like” manner (e.g., similar to the use of bank notes or cash to execute financial transactions).

A central bank may be aiming to reduce the printing of physical cash. Instead, by using certain embodiments of the methods and systems described herein, the same entity (e.g., the central bank) can provide a digital representation of the cash.

A central bank may use a blockchain platform (e.g., a private blockchain network) to issue one or more digital tokens. An end user can download a digital wallet application onto a computing device of the end user. The digital tokens may be deemed legal tender. The funds may be received in current digital wallet application (e.g., APPLE PAY or other Mobile Money Technology). The funds may be accessed via short message service (SMS). The user may present a QR code to effect the transfer of funds to merchants for purchases. The user may transfer funds to other individuals (e.g., friends and family) who also have the digital wallet application.

In one embodiment, the digital wallet application is designed to integrate, via blockchain and non-blockchain means, directly with a central bank or monetary authority as the issuer of Bank Notes (and therefore may be referred to as “Central” or “Central Bank”). The digital wallet application (which may be referred to as a “Sovereign Wallet”) may allow for a “Sovereign Identity” that is used for identification when needed (e.g., using a “document” screen). The digital wallet application may share “Know Your Customer” (KYC) integration. The digital wallet application may provide data access permission and/or broadcasting.

As will be understood by those of skill in the art, a digital wallet that leverages a blockchain network (and which may be referred to as a blockchain wallet) is an application that provides functionality for monitoring and conducting cryptocurrency transactions, which are recorded on the blockchain network. A blockchain wallet identifier (similar to or including a cryptographic public key) is associated with a private key and the user of the blockchain wallet uses the private key to access the data managed by the digital wallet. The end user may use a digital wallet application to conduct transactions involving funds managed by the blockchain wallet. The digital wallet application may execute in accordance with one or more smart contracts. The digital wallet application may use one or more application programming interfaces (APIs) to access and instruct the blockchain wallet.

For legal and regulatory sensitivities, Central Bank Digital Currency (CBDC) may be implemented with Direct and Indirect issuance of the CBDC Tokens. In one embodiment, this solution includes providing a Blockchain-Based digital wallet application to establish a trusted and secure payment platform that does not rely on the established banking infrastructure (e.g., relies on blockchains instead).

In one embodiment, the solution is designed to give the Issuer full and accurate visibility into the payments it participates in. The Central Bank guarantees to settle transactions with “Digital Legal Tender”. The digital wallet will be accepted for online and non-cash transaction “cash-like” models. Identity management functionality may be provided to meet standards for avoiding fraud and identity theft.

In one embodiment, the base cash digital wallet application framework has a plurality of characteristics. The digital wallet application does not impose restrictions on who may use the digital wallet application (e.g., any user, whether or not a bank account holder, may acquire the digital wallet application and use it for managing digital currency). The digital wallet application may represent an account at a Federal Reserve. The digital wallet and currency services may be managed by Central Bank. The digital wallet and currency services may be managed by an entity providing the methods and systems described herein on behalf of the central bank. The wallet application may provide the same KYC level as with Cash (to further provide a fully “cash-like” model). The CBDC received is considered a Legal Tender (e.g., accepted form of digital payment channel and settlement done directly at the Real Time Gross Settlement (RTGS) Account Levels).

Capabilities of the digital wallet application may include, without limitation, functionality for signing up customers, for looking up identification documents (e.g., birth certificate, SSC, Gov ID, etc.), for receiving funds, for paying funds, for sending funds, and for leveraging smart services (e.g., algorithms and deep learning) through the use, for example, of a smart contract specified for a private block chain established by, or on behalf of, a Central Bank.

The digital wallet application may be “legally” provisioned by the Central Bank. The digital wallet application may be sovereign to the individual who owns it. The digital wallet application may be GDPR compliant. The digital wallet application may be PSD2 compliant. The digital wallet application may be SMS-enabled. The digital wallet application may be QR Code enabled. Use of the digital wallet application may align to the cash model in a number of characteristics (e.g., anonymity, traceability, universal acceptance, and key management). The digital wallet application may leverage a hybrid blockchain model, using, e.g., distributed ledger technology but making that usage optional and/or task-specific and issuing currency via a Blockchain network as a default but making that usage optional. In a blockchain deployment, the federal reserve bank is the issuer (e.g., anchor), the ledger maintains gross and real time balances, the wallet is owned by the individual, and the data is fully sovereign. The government may use data with permission to perform certain activities (i.e., Payments or Shared Know Your Customer validations).

The methods and systems described herein may therefore provide a Digital Cash Infrastructure Framework, using CBDC. Such a framework may establish a platform for using CBDC (or “digital cash”). Such a platform may include an application programming interface that standardizes access to digital cash services (providing, in effect, a “digital cash as a service” platform). Such services may include, without limitation, wallet integration, bank integration, KYC validation, and payment settlement services.

A digital cash infrastructure built with CBDC may address the inclusion and inequality gaps left by conventional banking systems. The methods and systems described herein, therefore, may provide a framework that will aim to: provide users with a digital means to hold and pay for anything with “Digital Cash”, boost liquidity in the market with real time and final settlement, interoperate with banks and non-banks, leverage blockchain networks for trust, transparency and privacy, and disincentivize bad actors. The digital cash infrastructure described herein may include a framework providing a “base” in the financial infrastructure. In such an embodiment, whether or not a user has a conventional bank account, the user may have access to cash digitally. A technical implementation of the digital cash infrastructure described herein may address the pain points of the cash-based population, including unbanked individuals and merchants, including preserving financial stability by modernizing cash and presenting economic and monetary policy perspectives.

Broadly defined, CBDC is a form of money issued by a central bank or monetary authority, i.e The Federal Reserve, just like conventional cash is issued, and is a central bank liability that is accepted as legal tender. It differs from the traditional forms of money because of the technology used to issue it as a digital token with defined programmable attributes. The role of cash in the economy is vital in many ways. Above all, people prefer the concept of having cash because it allows the freedom and privacy of their financial decisions. Whether they privately want to save or spend, cash offers unique benefits that makes it still the most widely used form of payment. Further, cash is the most trusted, reliable, legal means of payment and allows for privacy transactions. As of February 2020, $1.8 Trillion dollars in circulation. In the post COVID-19 world, small and large institutions are already accelerating their digital transformation. In order to access goods and services digitally, cash users must have compatible, digital, payment solutions. The banked population has access to those solutions with debit and credit cards and other mobile apps. By contrast, a cash user who is unbanked or underbanked must find a way to convert cash to a bank deposit or a prepaid card in order to access it in a digital form (debit card, zelle, venmo, etc.). In the case of a check deposit, the fees and the delay in accessing funds are pain points for unbanked. Given the highly concentrated paper model, introducing cash in digital form helps diversify the methods through which people can get and use cash. Further, the use of digital cash, given the right design, should have little impact on the traditional banking sector, while contributing to market stability, economic growth and inclusion.

In the framework described herein, digital cash may be issued on a private blockchain network. In one embodiment, the private blockchain network is a permissioned Ethereum blockchain network (also referred to herein as a “Digital Cash Blockchain”), with an integrated platform of settlement and wallet services. In one embodiment, digital cash has the following properties: the digital cash is a non-interest bearing, self-contained instrument (issued by the federal reserve or a delegate) that is a central bank liability (no intermediary) providing a universally accepted form of payment, allowing for private transactions and instant final settlement.

Technologies are available for application to financial instrument innovation, including, without limitation, mechanism design (as part of game theory), with its auctions, mechanisms for collective actions, Vickrey-Clarke-Groves mechanism, voting mechanisms, etc., smart contracts as a way to handle relationships between counterparties in a trustless manner, to automatically re-align participants incentives and actions, and more. Digital currencies with their instant settlement are arguably still underappreciated in their potential to reduce friction in commercial and social activities. Having a blockchain run by the government may enable a host of new use cases.

A Digital Cash Blockchain may be implemented in a framework for establishing a resilient and trusted network of Digital Cash issuer and users. In some embodiments, this may include an Ethereum deployment and replicate the current Federal Reserve System to define the initial network participants and roles. Further, blockchain technology can embed trust, compliance, privacy and transparency in such networks. Three key considerations for the framework are privacy, transparent and embedded compliance, and interoperability. In one embodiment, the methods and systems described herein implement cryptography technologies to provide privacy.

In one embodiment, a three-step process implements a zero-knowledge computation for information revelation, the process including: implementing privacy-sensitive processes directly on trusted servers (pertinent state and communication with the trusted servers is encrypted, but the data being processed by the servers is not); running the servers from the first step in a trusted execution enclave, using, for example, and without limitation, Azure Confidential Computing or similar technology (providing privacy guarantees as long as the enclave itself is secure); and implementing the privacy-sensitive processing from the first two steps as secure multiparty computation (providing information-theoretic privacy guarantees as long as the honest parties participating in the computation meet certain threshold). This may be implemented, as an example and without limitation, on top of Partisia's Privacy Blockchain.

Use of a private blockchain network may guarantee data integrity—that no party can manipulate the data violating the rules of the platform. Furthermore, blockchain technology is natively transparent. With the addition of a privacy layer as part of the methods and systems described herein, the system maintains the blockchain transparency and introduces law enforcement compliance with government accountability.

In one embodiment, the methods and systems described herein include a platform that implements anonymous and confidential transaction processing, while also allowing law enforcement to selectively reveal the accounts participating in specific transactions in an auditable way. This also ensures accountability of compliance to privacy laws.

Anonymity refers to the identity of the transaction participants being hidden. This is in line with users' preference for privacy of the identity even if their activity is publicly broadcasted. Confidentiality refers to the transaction amounts and account balances remaining hidden to observers of the blockchain. This can apply also to any data passed to smart contracts. In one embodiment, the system implements a partially homomorphic ElGamal encryption to store account balances and zero-knowledge proofs to maintain data integrity and correctness when transacting with hidden transaction amounts.

The platform may enforce compliance of payments in respect to, e.g., anti-money laundering (AML) rules programmatically—transactions are not accepted if they fail to pass the required validation.

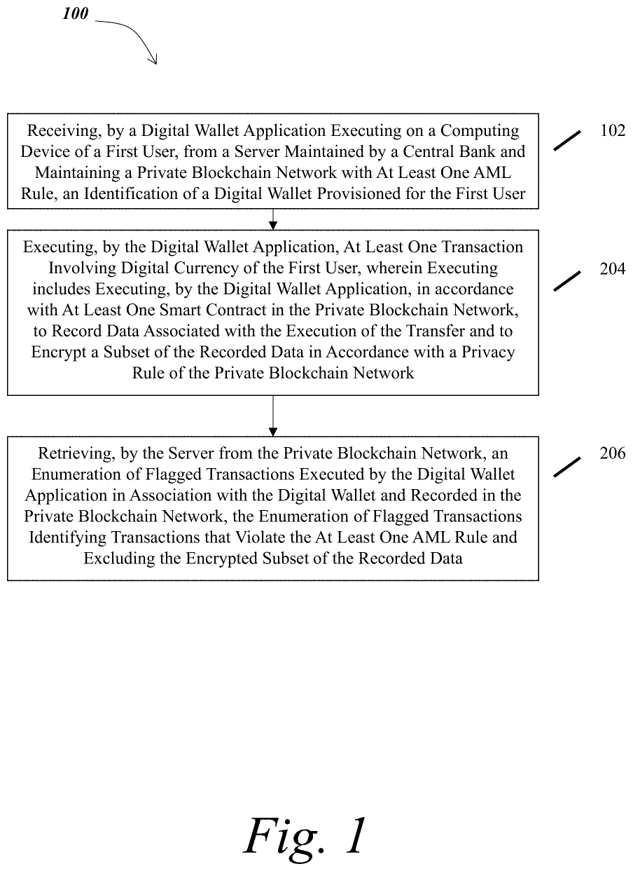

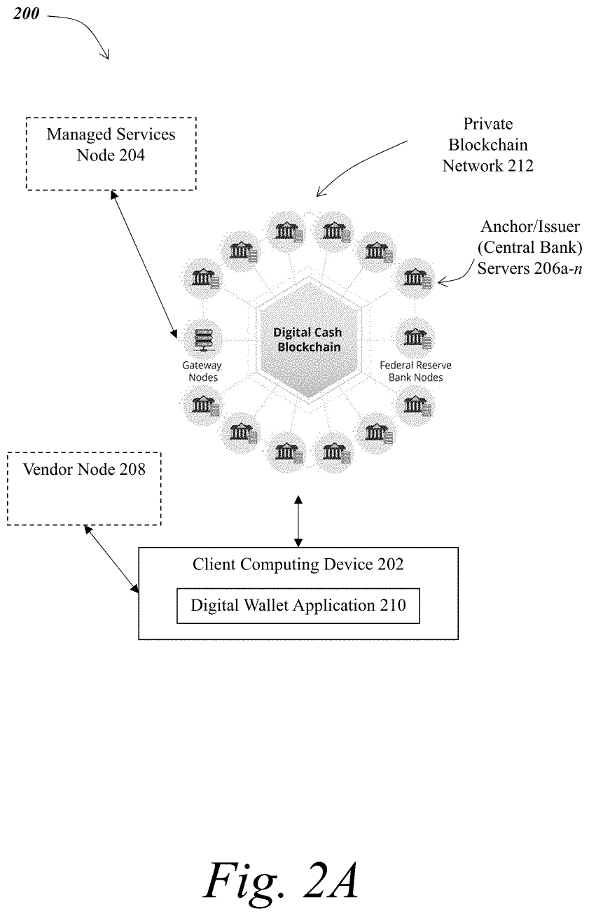

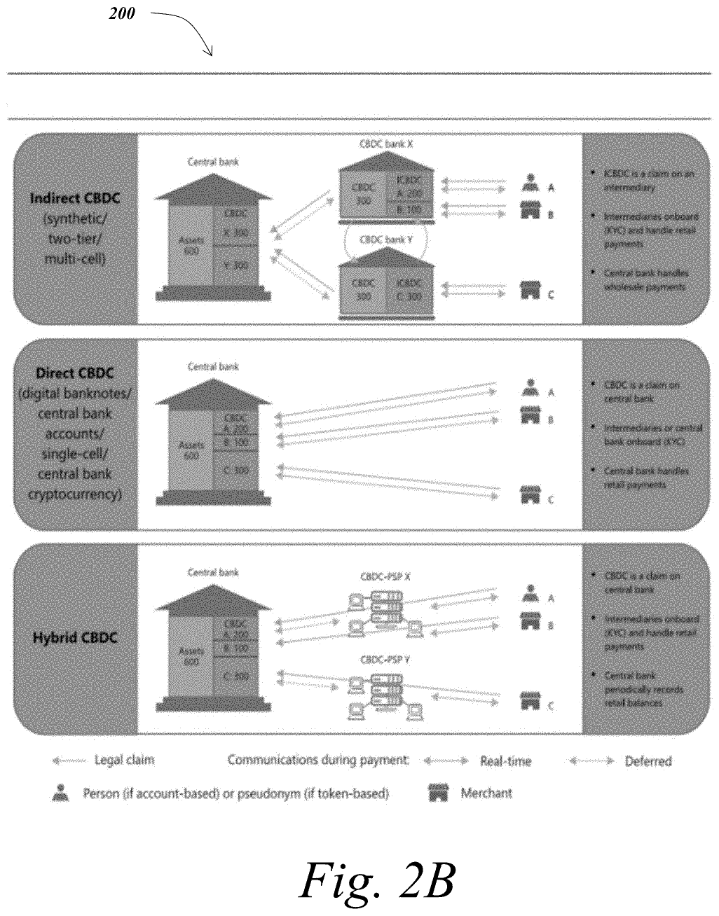

Referring now to FIG. 1, and in connection with FIGS. 2A-2B, a flow diagram depicts one embodiment of a method 100 for implementing, within a blockchain platform having at least one anti-money laundering (AML) rule, pseudo-anonymous and confidential transaction processing for digital currency issued by a central bank. The method 100 includes receiving, by a digital wallet application 210 executing on a computing device 202 of a first user, from a server 206a maintained by a central bank and maintaining a private blockchain network 212 with at least one AML rule, an identification of a digital wallet provisioned for the first user (102). The method 100 includes executing, by the digital wallet application 210, at least one transaction involving digital currency of the first user, wherein executing includes: executing, by the digital wallet application 210, in accordance with at least one smart contract in the private blockchain network 212, to record data associated with the execution of the transfer and to encrypt a subset of the recorded data in accordance with a privacy rule of the private blockchain network 212 (104). The method 100 includes retrieving, by the server 206a from the private blockchain network 212, an enumeration of flagged transactions executed by the digital wallet application 210 in association with the digital wallet and recorded in the private blockchain network 212, the enumeration of flagged transactions identifying transactions that violate the at least one AML rule and excluding the encrypted subset of the recorded data (106).

As depicted in FIG. 2A, the private blockchain network 212 may include a plurality of anchor/issuer (central bank) servers 206a-n. The method 100 may include executing the private blockchain network 212 within a trusted execution enclave. The private blockchain network 212 may be executed by the same entity that executes the servers 206a-n; that is, the Central Bank or an entity doing so on behalf of the Central Bank. The system described herein may use a permissioned private network that reflects the current structure of The Federal Reserve System (e.g., one federal and twelve regional reserve banks) in which reserve banks would provide issuance, settlement and validation of the network activities. The API Platform allows broad integration to wallet and identity service providers.

The method 100 includes receiving, by a digital wallet application 210 executing on a computing device 202 of a first user, from a server 206a maintained by a central bank and maintaining a private blockchain network 212 with at least one AML rule, an identification of a digital wallet provisioned for the first user (102). The digital wallet application 210 may receive the public key of the first user from the server 206a. The digital wallet application 210 may receive the private key of the first user from the server 206a. The digital wallet application 210 may receive an identifier of the digital wallet from the server 206a. The digital wallet application 210 may execute one or more onboarding processes to assist the first user in setting up and accessing the digital wallet. The digital wallet application 210 may execute one or more transaction processes to assist the first user with executing funds transfers with the funds in the digital wallet.

The method 100 includes executing, by the digital wallet application 210, at least one transaction involving digital currency of the first user, wherein executing includes executing, by the digital wallet application 210, at least one smart contract in the private blockchain network 212, to record data associated with the execution of the transfer and to encrypt a subset of the recorded data in accordance with a privacy rule of the private blockchain network 212 (104). Executing may include executing a transfer of central bank digital currency tokens. Executing may include executing a transfer of Subscriber Identity Module (SIM) card based electronic cash. Since a user's private key is embedded in a token (e.g., a token issued as central bank digital currency), the user's private key is used to authorize transactions and enables token-level privacy mechanisms. Similarly, AML rules may be run against the tokens themselves and each region or country may have customized rules configured for the needs of that region or country.

Executing the transaction in accordance with one or more policies of the private blockchain network 212 may include encryption a subset of the transaction data. A smart contract associated with the private blockchain network 212 may specify the one or more policies. A user interface may allow an administrative user associated with the central bank and accessing the server 206a to specify the one or more policies.

Executing the transaction in accordance with one or more policies of the smart contract may include encryption a subset of the transaction data. Therefore, the method 100 may include executing in accordance with least one smart contract by encrypting an identifier of the first user. The method 100 may include executing in accordance with at least one smart contract by encrypting an identifier of a second user involved in at least one transaction with the first user. The method 100 may include executing in accordance with at least one smart contract by encrypting an amount of digital currency involved in a transaction of the first user. The method 100 may include executing in accordance with at least one smart contract by encrypting an account balance of the first user. The method 100 may include executing in accordance with at least one smart contract by encrypting an account balance of a second user involved in at least one transaction with the first user. In some embodiments, the digital wallet application instructs the digital wallet to execute the transaction and to encrypt one or more portions of the transaction data.

The method 100 includes retrieving, by the server 206a from the private blockchain network 212, an enumeration of flagged transactions executed by the digital wallet application 210 in association with the digital wallet and recorded in the private blockchain network 212, the enumeration of flagged transactions identifying transactions that violate the at least one AML rule and excluding the encrypted subset of the recorded data (106). The method may include executing, by the server 206a, at least one rule of the private blockchain network 212, the at least one rule specifying a filter to apply to transactions recorded in the private blockchain network 212 and a frequency with which to apply the filter and requesting, by the server 206a, from the private blockchain network 212, generation of the enumeration of flagged transactions by application of the filter.

The Digital Cash Blockchain system described herein enables compliance with jurisdictional requirements to disclose information about specific transactions. A zero-knowledge computation oracle, for example, may monitor the blockchain. The zero-knowledge computation oracle, as an additional example, may receive a request for encrypted information, verify authorization and, if it is deemed correct, reveal the encrypted information to the party requesting it outside the blockchain. The request for access to the encrypted information itself may be recorded in the blockchain. In this way, information disclosure is logged on the blockchain and can be scrutinized by democratic institutions. The method 100 may therefore include providing, by the server 206a, to a key management server (not shown), at least one authentication credential associated with a second user, the second user authorized to access the encrypted subset of the recorded data and receiving, by the server, a decryption of the encrypted subset of the recorded data. The key management server may be executed by the same entity that executes the servers 206a-n; that is, the Central Bank or an entity doing so on behalf of the Central Bank. The method 100 may include enforcing, by the central bank, at least one anti-money laundering compliance requirement in connection with the enumeration of flagged transactions.

The platform may provide protection from accidental loss or proven theft of private keys by allowing multisig transactions. Law enforcement is able to unlock or transfer funds using a similar mechanism to the one used for disclosing transaction participants. All such interventions are recorded on the blockchain and are subject to public scrutiny. As the system may, in some embodiments, implement a permissioned blockchain, node operators have legal entities associated with them, providing additional accountability and safety.

Gateway Nodes or Services may allow any financial institution (or any authorized financial institution) to connect to the Digital Cash Blockchain system and utilize its infrastructure as cash becomes deposits, and vice versa. The private blockchain network 212 can be integrated with existing systems and does not require major retooling of the current banking system. Managed services nodes 204 may use one or more APIs in an API platform to connect with the private blockchain 212 via one or more gateway nodes as shown in FIG. 2A. Managed services may include, without limitation, digital wallet integration, payment settlement, digital identify, bank integration, and other micro services. Similarly, vendor nodes 208 may interact with the digital wallets (and the associated digital wallet application 210) to provide additional services to end users. Users, including unbanked users, may therefore access services such as P2P transfer, bank deposits, merchant services, and other service providers via vendor nodes 208 while accessing cash token issuance, sovereign wallets management, ledger management, audit and reconciliation functionality, and offline transaction support via the digital wallet application 210. The digital wallet application 210 may include functionality for onboarding users, executing sovereign wallet protocols (which allow for the sending and receiving of funds and sending payments), sovereign identity protocol (KYC), security, anti-money laundering rule compliance, data protection, and third party integration (e.g., with the US Treasury and authorized Vendors).

As shown in FIG. 2B, the method 100 may include providing indirect central bank digital currency (ICBDC) functionality via a synthetic/two-tier multi-cell to satisfy a claim on an intermediary, allowing intermediaries to onboard (KYC) and handle retail payments while the central bank handles wholesale payments. As shown in FIG. 2B, the method 100 may also include providing Direct CBDC (DCBDC) functionality via digital banknotes/central bank accounts/single cell/central bank cryptocurrency to satisfy a CBDC claim on the central bank, in which intermediaries or the central bank onboards (KYC), and the central bank also handles retail payments. As shown in FIG. 2B, the method 100 may also include providing hybrid CBDC functionality to satisfy a CBDC claim on the central bank, in which intermediaries onboard (KYC) and handle retail payments while the central bank periodically records retail balances.

By using the APIs, policies, and smart contract functionality of private blockchain networks, Central Banks that implement embodiments of the methods and systems described herein may allow users to access digital wallets, whether or not the users have bank accounts. Central Banks may function as anchor issuers of tokens while embedding privacy mechanisms at the token level to allow cash transactions while maintaining privacy. This allows a measure of anonymity (pseudo-anonymity) while allowing Central Banks to execute functionality for auditing key transactions without access to user identifiers or balances unless the audit administrator provides additional authentication credentials (e.g., proving that they are authorized to access unencrypted data). Additionally, the enforcement of anti-money laundering rules that are embedded into the token and can run against the tokens themselves allow for a combination of AML enforcement while preserving user privacy.

Physical Cash has 100% availability and reliability; it is anonymous; it is an immediate direct medium of settlement. Physical cash allows the unbanked and under-banked to participate in the economy. Digital cash must have these same characteristics. Many people will be leery of the government deploying digital cash into the economy. Digital cash can have privacy, like cash, and transparency, like a blockchain. This helps build trust in the ecosystem since people can transact in the same way as if they had paper cash, while providing functionality to distribute and trace transactions, if needed. Partnerships may be developed with key organizations and companies spanning across industries including, without limitation: banking and financial institutions, community organizations supporting unbanked and closing the wealth disparity gap, organizations supporting development of CBDC, Local/Regional Governments supporting financial literacy and digital adoption, Local/Regional Merchants Adopting Digital Cash Options, and Startup Technology Firms in FinTech, Financial literacy, and digital cash payments. By partnering with trusted community organizations, entities implementing the methods and systems described herein may bring financial technology innovation, via Digital Cash, to sectors of the United States that have been forgotten or ignored, simply because of the difficulty in reaching this portion of the un-banked population. As financial needs are more directly addressed among this core segment of the population, the expectation is that overall GDP experiences a positive lift that can continue to trend upwards as usage and adoption of digital cash expand nationwide. The methods and systems described herein may provide functionality to provide trust, privacy, compliance and interoperability; a Digital Cash Infrastructure would establish an efficient “Cash to People” model that can support unbanked, cash-based populations.

In some embodiments, the system 100 includes non-transitory, computer-readable medium comprising computer program instructions tangibly stored on the non-transitory computer-readable medium, wherein the instructions are executable by at least one processor to perform each of the steps described above in connection with FIGS. 1 and 2A-2B.

It should be understood that the systems described above may provide multiple ones of any or each of those components and these components may be provided on either a standalone machine or, in some embodiments, on multiple machines in a distributed system. The phrases ‘in one embodiment,’ ‘in another embodiment,’ and the like, generally mean that the particular feature, structure, step, or characteristic following the phrase is included in at least one embodiment of the present disclosure and may be included in more than one embodiment of the present disclosure. Such phrases may, but do not necessarily, refer to the same embodiment. However, the scope of protection is defined by the appended claims; the embodiments mentioned herein provide examples.

The systems and methods described above may be implemented as a method, apparatus, or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be LISP, PROLOG, PERL, C, C++, C#, JAVA, or any compiled or interpreted programming language.

Each such computer program may be implemented in a computer program product tangibly embodied in a machine-readable storage device for execution by a computer processor. Method steps may be performed by a computer processor executing a program tangibly embodied on a computer-readable medium to perform functions of the methods and systems described herein by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices, firmware, programmable logic, hardware (e.g., integrated circuit chip; electronic devices; a computer-readable non-volatile storage unit; non-volatile memory, such as semiconductor memory devices, including EPROM, EEPROM, and flash memory devices; magnetic disks such as internal hard disks and removable disks; magneto-optical disks; and CD-ROMs). Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data (including, for example, instructions for storage on non-transitory computer-readable media) from a second computer providing access to the programs via a network transmission line, wireless transmission media, signals propagating through space, radio waves, infrared signals, etc.

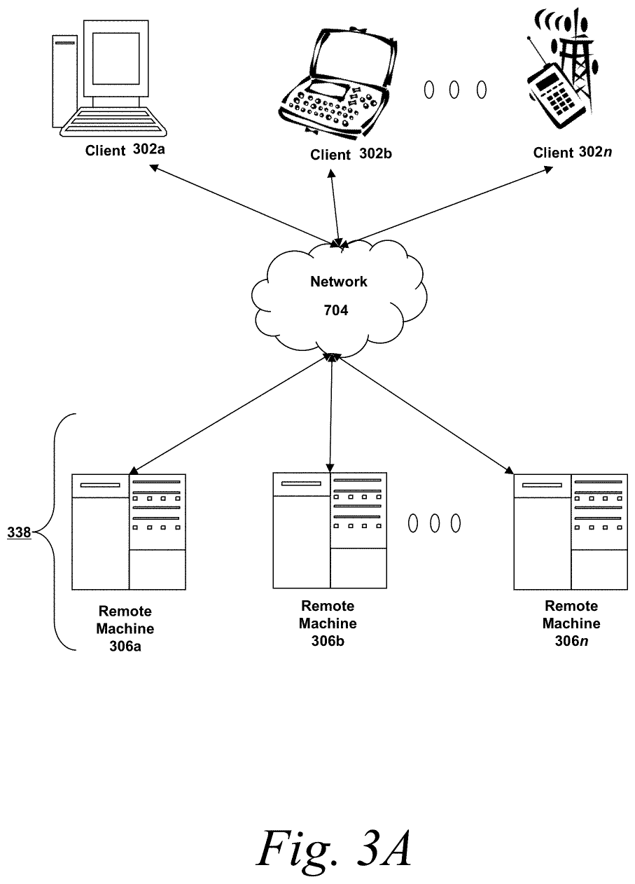

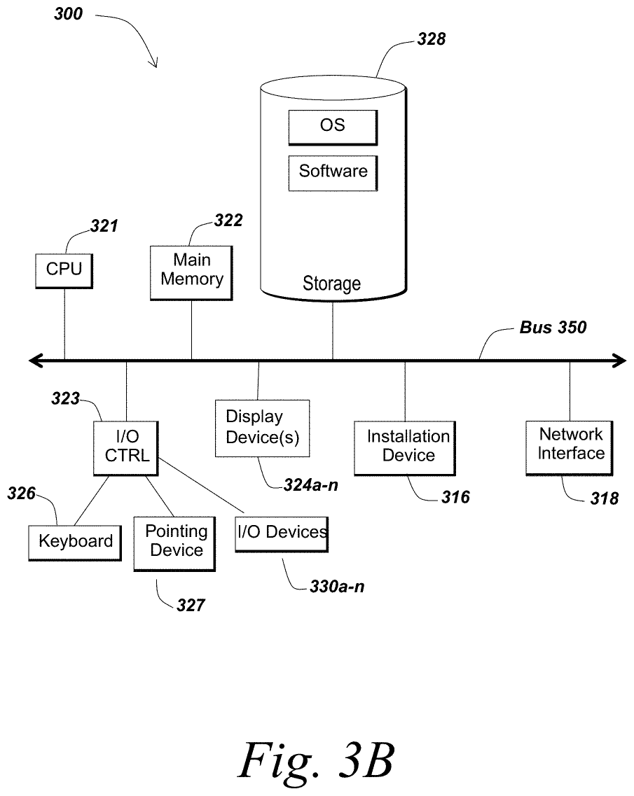

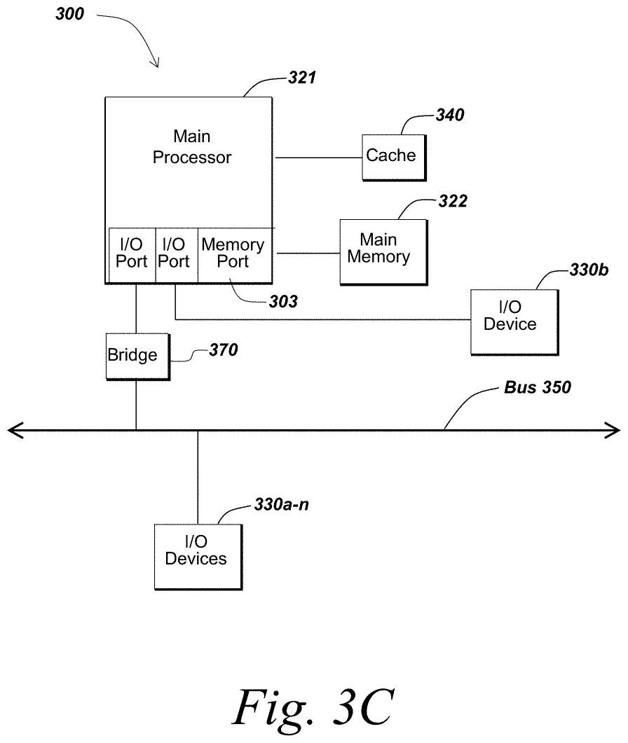

Referring now to FIGS. 3A, 3B, and 3C, block diagrams depict additional detail regarding computing devices that may be modified to execute novel, non-obvious functionality for implementing the methods and systems described above.

Referring now to FIG. 3A, an embodiment of a network environment is depicted. In brief overview, the network environment comprises one or more clients 302a-302n (also generally referred to as local machine(s) 302, client(s) 302, client node(s) 302, client machine(s) 302, client computer(s) 302, client device(s) 302, computing device(s) 302, endpoint(s) 302, or endpoint node(s) 302) in communication with one or more remote machines 306a-306n (also generally referred to as server(s) 306 or computing device(s) 306) via one or more networks 304.

Although FIG. 3A shows a network 304 between the clients 302 and the remote machines 306, the clients 302 and the remote machines 306 may be on the same network 304. The network 304 can be a local area network (LAN), such as a company Intranet, a metropolitan area network (MAN), or a wide area network (WAN), such as the Internet or the World Wide Web. In some embodiments, there are multiple networks 304 between the clients 302 and the remote machines 306. In one of these embodiments, a network 304′ (not shown) may be a private network and a network 304 may be a public network. In another of these embodiments, a network 304 may be a private network and a network 304′ a public network. In still another embodiment, networks 304 and 304′ may both be private networks. In yet another embodiment, networks 304 and 304′ may both be public networks.

The network 304 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, an SDH (Synchronous Digital Hierarchy) network, a wireless network, and a wireline network. In some embodiments, the network 304 may comprise a wireless link, such as an infrared channel or satellite band. The topology of the network 304 may be a bus, star, or ring network topology. The network 304 may be of any such network topology as known to those ordinarily skilled in the art capable of supporting the operations described herein. The network may comprise mobile telephone networks utilizing any protocol or protocols used to communicate among mobile devices (including tables and handheld devices generally), including AMPS, TDMA, CDMA, GSM, GPRS, UMTS, or LTE. In some embodiments, different types of data may be transmitted via different protocols. In other embodiments, the same types of data may be transmitted via different protocols.

A client 302 and a remote machine 306 (referred to generally as computing devices 300) can be any workstation, desktop computer, laptop or notebook computer, server, portable computer, mobile telephone, mobile smartphone, or other portable telecommunication device, media playing device, a gaming system, mobile computing device, or any other type and/or form of computing, telecommunications or media device that is capable of communicating on any type and form of network and that has sufficient processor power and memory capacity to perform the operations described herein. A client 302 may execute, operate or otherwise provide an application, which can be any type and/or form of software, program, or executable instructions, including, without limitation, any type and/or form of web browser, web-based client, client-server application, an ActiveX control, or a JAVA applet, or any other type and/or form of executable instructions capable of executing on client 302.

In one embodiment, a computing device 306 provides functionality of a web server. In some embodiments, a web server 306 comprises an open-source web server, such as the APACHE servers maintained by the Apache Software Foundation of Delaware. In other embodiments, the web server executes proprietary software, such as the INTERNET INFORMATION SERVICES products provided by Microsoft Corporation of Redmond, Wash., the ORACLE IPLANET web server products provided by Oracle Corporation of Redwood Shores, Calif., or the ORACLE WEBLOGIC products provided by Oracle Corporation of Redwood Shores, Calif.

In some embodiments, the system may include multiple, logically-grouped remote machines 306. In one of these embodiments, the logical group of remote machines may be referred to as a server farm 338. In another of these embodiments, the server farm 338 may be administered as a single entity.

FIGS. 3B and 3C depict block diagrams of a computing device 300 useful for practicing an embodiment of the client 302 or a remote machine 306. As shown in FIGS. 3B and 3C, each computing device 300 includes a central processing unit 321, and a main memory unit 322. As shown in FIG. 3B, a computing device 300 may include a storage device 328, an installation device 316, a network interface 318, an I/O controller 323, display devices 324a-n, a keyboard 326, a pointing device 327, such as a mouse, and one or more other I/O devices 330a-n. The storage device 328 may include, without limitation, an operating system and software. As shown in FIG. 3C, each computing device 300 may also include additional optional elements, such as a memory port 303, a bridge 370, one or more input/output devices 330a-n (generally referred to using reference numeral 330), and a cache memory 340 in communication with the central processing unit 321.

The central processing unit 321 is any logic circuitry that responds to and processes instructions fetched from the main memory unit 322. In many embodiments, the central processing unit 321 is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; those manufactured by International Business Machines of White Plains, N.Y.; or those manufactured by Advanced Micro Devices of Sunnyvale, Calif. Other examples include SPARC processors, ARM processors, processors used to build UNIX/LINUX “white” boxes, and processors for mobile devices. The computing device 300 may be based on any of these processors, or any other processor capable of operating as described herein.

Main memory unit 322 may be one or more memory chips capable of storing data and allowing any storage location to be directly accessed by the main processor 321. The main memory 322 may be based on any available memory chips capable of operating as described herein. In the embodiment shown in FIG. 3B, the processor 321 communicates with main memory 322 via a system bus 350. FIG. 3C depicts an embodiment of a computing device 300 in which the processor communicates directly with main memory 322 via a memory port 303. FIG. 3C also depicts an embodiment in which the main processor 321 communicates directly with cache memory 340 via a secondary bus, sometimes referred to as a backside bus. In other embodiments, the main processor 321 communicates with cache memory 340 using the system bus 350.

In the embodiment shown in FIG. 3B, the processor 321 communicates with various I/O devices 330 via a local system bus 350. Various buses may be used to connect the central processing unit 321 to any of the I/O devices 330, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 324, the processor 321 may use an Advanced Graphics Port (AGP) to communicate with the display 324. FIG. 3C depicts an embodiment of a computing device 300 in which the main processor 321 also communicates directly with an I/O device 330b via, for example, HYPERTRANSPORT, RAPIDIO, or INFINIBAND communications technology.

One or more of a wide variety of I/O devices 330a-n may be present in or connected to the computing device 300, each of which may be of the same or different type and/or form. Input devices include keyboards, mice, trackpads, trackballs, microphones, scanners, cameras, and drawing tablets. Output devices include video displays, speakers, inkjet printers, laser printers, 3D printers, and dye-sublimation printers. The I/O devices may be controlled by an I/O controller 323 as shown in FIG. 3B. Furthermore, an I/O device may also provide storage and/or an installation device 316 for the computing device 300. In some embodiments, the computing device 300 may provide USB connections (not shown) to receive handheld USB storage devices such as the USB Flash Drive line of devices manufactured by Twintech Industry, Inc. of Los Alamitos, Calif.

Referring still to FIG. 3B, the computing device 300 may support any suitable installation device 316, such as a floppy disk drive for receiving floppy disks such as 3.5-inch, 5.25-inch disks or ZIP disks; a CD-ROM drive; a CD-R/RW drive; a DVD-ROM drive; tape drives of various formats; a USB device; a hard-drive or any other device suitable for installing software and programs. In some embodiments, the computing device 300 may provide functionality for installing software over a network 304. The computing device 300 may further comprise a storage device, such as one or more hard disk drives or redundant arrays of independent disks, for storing an operating system and other software. Alternatively, the computing device 300 may rely on memory chips for storage instead of hard disks.

Furthermore, the computing device 300 may include a network interface 318 to interface to the network 304 through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, 802.15.4, Bluetooth, ZIGBEE, CDMA, GSM, WiMax, and direct asynchronous connections). In one embodiment, the computing device 300 communicates with other computing devices 300′ via any type and/or form of gateway or tunneling protocol such as Secure Socket Layer (SSL) or Transport Layer Security (TLS). The network interface 318 may comprise a built-in network adapter, network interface card, PCMCIA network card, card bus network adapter, wireless network adapter, USB network adapter, modem, or any other device suitable for interfacing the computing device 300 to any type of network capable of communication and performing the operations described herein.

In further embodiments, an I/O device 330 may be abridge between the system bus 350 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 300 of the sort depicted in FIGS. 3B and 3C typically operates under the control of operating systems, which control scheduling of tasks and access to system resources. The computing device 300 can be running any operating system such as any of the versions of the MICROSOFT WINDOWS operating systems, the different releases of the UNIX and LINUX operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS CE, WINDOWS XP, WINDOWS 7, WINDOWS 8, and WINDOWS VISTA, WINDOWS 10 all of which are manufactured by Microsoft Corporation of Redmond, Wash.; MAC OS manufactured by Apple Inc. of Cupertino, Calif.; OS/2 manufactured by International Business Machines of Armonk, N.Y.; Red Hat Enterprise Linux, a Linus-variant operating system distributed by Red Hat, Inc., of Raleigh, N.C.; Ubuntu, a freely-available operating system distributed by Canonical Ltd. of London, England; or any type and/or form of a Unix operating system, among others.

Having described certain embodiments of methods and systems for implementing, within a blockchain platform having at least one anti-money laundering rule, pseudo-anonymous and confidential transaction processing for digital currency issued by a central bank, it will be apparent to one of skill in the art that other embodiments incorporating the concepts of the disclosure may be used. Therefore, the disclosure should not be limited to certain embodiments, but rather should be limited only by the spirit and scope of the following claims.

What is claimed is:

1. A method for implementing, within a blockchain platform having at least one anti-money laundering (AML) rule, pseudo-anonymous and confidential transaction processing for digital currency issued by a central bank, the method comprising:
receiving, by a digital wallet application executing on a computing device of a first user, from a server maintained by a central bank and maintaining a private blockchain network with at least one AML rule, an identification of a digital wallet provisioned for the first user;
executing, by the digital wallet application, at least one transaction involving digital currency of the first user, wherein executing further comprises:
executing, by the digital wallet application, in accordance with at least one smart contract in the private blockchain network, to record data associated with the execution of the transfer and to encrypt a subset of the recorded data in accordance with a privacy rule of the private blockchain network; and
retrieving, by the server from the private blockchain network, an enumeration of flagged transactions executed by the digital wallet application in association with the digital wallet and recorded in the private blockchain network, the enumeration of flagged transactions identifying transactions that violate the at least one AML rule and excluding the encrypted subset of the recorded data.

2. The method of claim 1, wherein executing further comprises executing a transfer of central bank digital currency tokens.

3. The method of claim 1, wherein executing further comprises executing a transfer of Subscriber Identity Module (SIM) card based electronic cash.

4. The method of claim 1 further comprising:
providing, by the server, to a key management server, at least one authentication credential associated with a second user, the second user authorized to access the encrypted subset of the recorded data;
receiving, by the server, a decryption of the encrypted subset of the recorded data; and
enforcing, by the central bank, at least one anti-money laundering compliance requirement in connection with the enumeration of flagged transactions.

5. The method of claim 1 further comprising executing the private blockchain network within a trusted execution enclave.

6. The method of claim 1, wherein retrieving the enumeration of transactions further comprises:
executing, by the server, at least one rule of the blockchain platform, the at least one rule specifying a filter to apply to transactions recorded in the blockchain and a frequency with which to apply the filter; and
requesting, by the server, from the private blockchain network, generation of the enumeration of flagged transactions by application of the filter.

7. The method of claim 1, wherein executing further comprises executing in accordance with the at least one smart contract by encrypting an identifier of the first user.

8. The method of claim 1, wherein executing further comprises executing in accordance with the at least one smart contract by encrypting an identifier of a second user involved in at least one transaction with the first user.

9. The method of claim 1, wherein executing further comprises executing in accordance with the at least one smart contract by encrypting an amount of digital currency involved in the transaction.

10. The method of claim 1, wherein executing further comprises executing in accordance with the at least one smart contract by encrypting an account balance of the first user.

11. The method of claim 1, wherein executing further comprises executing in accordance with the at least one smart contract by encrypting an account balance of a second user involved in at least one transaction with the first user.
